(19) United States
(12) Patent Application Publication
(10) Pub. No.: US 2024/0388139 A1
(43) Pub. Date: Nov. 21, 2024

(54) CLOAKING AND POWER MANAGEMENT IN WIRELESS POWER TRANSFER

(71) Applicant: Renesas Electronics America Inc., Milpitas, CA (US)

(72) Inventors: Adnan DZEBIC, Oakland, CA (US); Gustavo James MEHAS, Fall City, WA (US); Pooja AGRAWAL, Milpitas, CA (US)

(73) Assignee: Renesas Electronics America Inc., Milpitas, CA (US)

(21) Appl. No.: 18/423,496

(22) Filed: Jan. 26, 2024

Related U.S. Application Data
(60) Provisional application No. 63/502,153, filed on May 15, 2023.

(51) Int. Cl. H02J 50/80; H02J 7/00

(52) U.S. Cl. CPC H02J 50/80; H02J 7/00034; H02J 7/007182

(57) ABSTRACT

In an embodiment, an apparatus is disclosed. The apparatus includes a battery and a wireless power receiver. The wireless power receiver includes a controller and a memory subsystem. The controller is configured to perform a handshake with a wireless power transmitter. The handshake corresponds to a temporary suspension of a power transfer between the wireless power transmitter and the wireless power receiver. The controller is configured to transition the wireless power receiver from a power transfer mode, in which power is transferred wirelessly from the wireless transmitter to the wireless receiver, to a cloak mode, in which the power transfer is suspended, based on the handshake and obtain a supply of power from the battery based on the transition to the cloak mode, the power being configured for use by the controller to maintain power transfer state information about the temporarily suspended power transfer in the memory subsystem.

### CROSS-REFERENCE TO RELATED APPLICATION

This application claims the benefit of U.S. Provisional Application No. 63/502,153 filed on May 15, 2023. The entire content of U.S. Provisional Application No. 63/502,153 is incorporated herein by reference.

### BACKGROUND

The present disclosure relates in general to apparatuses and methods for power transfer and communication between wireless power transmitters and wireless power receivers.

Wireless power systems often include a power transmitter and a power receiver. When a transmission coil of the power transmitter and a receiver coil of the power receiver are positioned close to one another they form a transformer that facilitates inductive transmission of an alternating current (AC) power between the power transmitter and the power receiver. The power receiver often includes a rectifier circuit that converts the AC power into a direct current (DC) power that may be utilized for various loads or components that require DC power to operate. The power transmitter and the power receiver also utilize the transformer to exchange information or messages using various modulation schemes.

### SUMMARY

In an embodiment, an apparatus is disclosed. The apparatus comprises a battery and a wireless power receiver. The wireless power receiver comprises a controller and a memory subsystem. The controller is configured to perform a handshake with a wireless power transmitter. The handshake corresponds to a temporary suspension of a power transfer between the wireless power transmitter and the wireless power receiver. The controller is configured to transition the wireless power receiver from a power transfer mode, in which power is transferred wirelessly from the wireless transmitter to the wireless receiver, to a cloak mode, in which the power transfer is suspended, based on the handshake and obtain a supply of power from the battery based on the transition to the cloak mode, the power being configured for use by the controller to maintain power transfer state information about the temporarily suspended power transfer in the memory subsystem.

In an embodiment, an apparatus is disclosed. The apparatus comprises an application processor and a battery. The application processor is configured to receive an indication of a change in state of a wireless power receiver, determine that the change in state corresponds to a temporary suspension of a power transfer and cause power to be supplied to the wireless power receiver from the battery based on the determined change in state.

In an embodiment, an apparatus is disclosed that comprises a wireless power receiver. The wireless power receiver is configured to establish a power transfer contract with a wireless power transmitter and provide an indication to an application processor of the apparatus that corresponds to the establishment of the power transfer contract. The application processor is configured to receive the indication that the wireless power receiver has established a power transfer contract with the wireless power transmitter and cause power to be supplied to the wireless power receiver from the battery based on the receipt of the indication. The wireless power receiver is configured to provide the power received from the battery to a memory subsystem of the wireless power receiver. The memory subsystem is configured to maintain power transfer state information corresponding to the power transfer contract. The wireless power receiver is configured to execute a wireless power transfer between the wireless power transmitter and the wireless power receiver based on the power transfer contract and provide the transferred power to the battery.

The foregoing summary is illustrative only and is not intended to be in any way limiting. In addition to the illustrative aspects, embodiments, and features described above, further aspects, embodiments, and features will become apparent by reference to the drawings and the following detailed description. In the drawings, like reference numbers indicate identical or functionally similar elements.

### BRIEF DESCRIPTION OF THE DRAWINGS

FIG. 1 is a block diagram of an example system for wireless power transfer according to an embodiment.

FIG. 2 is a block diagram of a device comprising a wireless power receiver of the system of FIG. 1 according to an embodiment.

FIG. 3 is a flow diagram of an example process performed by the device of FIG. 2 according to an embodiment.

FIG. 4 is a signal diagram of an example process flow of the system of FIG. 1 according to an embodiment.

FIG. 5A is a diagram of example state transitions, power application and removal in the system of FIG. 1 according to an embodiment.

FIG. 5B is another diagram of example state transitions, power application and removal in the system of FIG. 1 according to an embodiment.

FIG. 6 is a block diagram illustrating the different power supply input options for a wireless power receiver according to an embodiment.

### DETAILED DESCRIPTION

Wireless power systems often need to manage the user expectation of constant charging even in the face of power transmitter or power receiver charging pauses due to thermal or other events. For example, the user may expect that when a device having a power receiver, e.g., a smart phone or another wirelessly powered device, is placed near a power transmitter, that the device will begin charging and continue charging until the charge is complete or until the user has removed the device from the proximity of the power transmitter. Pauses in charging due to thermal or other events, however, may disrupt the user's expectation of constant charging, for example, by causing a display or indicator of the device to indicate that no charging is occurring, causing the display to illuminate from a sleep or low power state due to a change in the charging mode, or in any other manner. Such indications may cause the user frustration or instill a belief that there is something wrong with either the power transmitter, power receiver or other components of their device when the pause may instead simply be due to other factors such as a temporary thermal event, e.g., battery heating during charging reaching a threshold temperature and charging being temporarily paused while the battery returns to a temperature suitable for further charging. Implementing solutions to these and other interrupted charging scenarios while also complying with existing and future wireless charging standards may be a challenge.

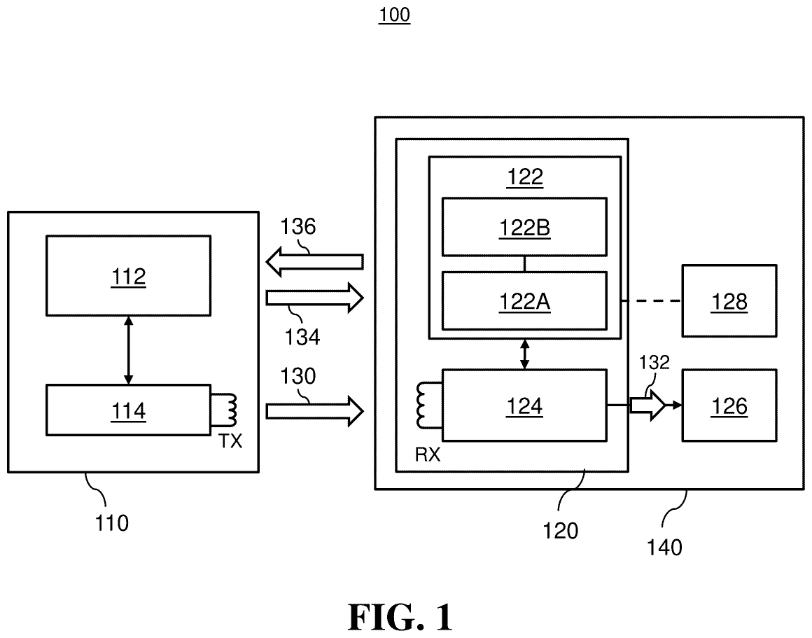

FIG. 1 is a diagram showing an example system 100 that implements wireless power transfer and communication according to an illustrative embodiment. System 100 comprises a power transmitter 110 and a power receiver 120 that are configured to wirelessly transfer power and data therebetween via inductive coupling. Power transmitter 110 may also be referred to herein as PTx 110 and power receiver 120 may also be referred to herein as PRx 120. While described herein as PTx 110 and PRx 120, each of PTx 110 and PRx 120 may be configured to both transmit and receive power or data therebetween via inductive coupling.

PTx 110 is configured to receive power from one or more power supplies and to transmit AC power to PRx 120 wirelessly. For example, PTx 110 may be configured for connection to a power supply such as, e.g., an AC power supply or a DC power supply. PTx 110 comprises a controller 112 and a power driver 114.

Controller 112 is configured to control and operate power driver 114. Controller 112 comprises, for example, a processor, central processing unit (CPU), field-programmable gate array (FPGA) or any other circuitry that is configured to control and operate power driver 114. While described as a CPU in illustrative embodiments, controller 112 is not limited to a CPU in these embodiments and may comprise any other circuitry that is configured to control and operate power driver 114. In an example embodiment, controller 112 is configured to control power driver 114 to drive a coil TX of the power driver 114 to produce a magnetic field. Power driver 114 is configured to drive coil TX at a range of frequencies and configurations defined by wireless power standards, such as, e.g., the Wireless Power Consortium (WPC) wireless charging (Qi) standard, the Power Matters Alliance (PMA) standard, the Alliance for Wireless Power (A for WP, or Rezence) standard or any other existing or future wireless power standards including the upcoming WPC Magnetic Power Profile (MPP) standard. Controller 112 may be configured as a separate component from power driver 114 or may be included as a part of power driver 114.

PRx 120 is configured to receive AC power transmitted from power transmitter 110 and to supply the power to one or more loads 126 or other components of a device 140 that is being charged. Device 140 may comprise, for example, a computing device, mobile device, mobile telephone, smart device, tablet, wearable device, or any other electronic device that is configured to receive power wirelessly. In an illustrative embodiment, device 140 comprises PRx 120. In other embodiments, PRx 120 may be separate from device 140 and connected to device 140 via a wire or other component that is configured to provide power to device 140.

PRx 120 comprises a CPU and memory subsystem 122 and a power rectifier 124. CPU and memory subsystem 122 comprises a controller 122A, for example, a processor, central processing unit (CPU), field-programmable gate array (FPGA) or any other circuitry that may be configured to control and operate power rectifier 124.

CPU and memory subsystem 122 also comprises memory subsystem 122B comprising memory or other components that are usable by controller 122A to control and operate power rectifier 124, maintain power transfer state information or store any other type of information for use by controller 122A.

Power rectifier 124 includes a coil RX and is configured to rectify power received via coil RX into a power type as needed for load 126. For example, power rectifier 124 is configured to rectify AC power received from coil RX into DC power which may then be supplied to load 126.

As an example, when PRx 120 is placed in proximity to PTx 110, the magnetic field produced by coil TX of power driver 114 induces a current in coil RX of power rectifier 124. The induced current causes AC power 130 to be inductively transmitted from power driver 114 to power rectifier 124. Power rectifier 124 receives AC power 130 and converts AC power 130 into DC power 132. DC power 132 is then provided by power rectifier 124 to load 126. Load 126 may comprise, for example, a battery charger and a battery of device 140, where the battery charger can be configured to charge the battery of device 140, a DC-DC converter that is configured to supply power to a processor, a display, or other electronic components of device 140, or any other load of device 140.

PTx 110 and PRx 120 are also configured to exchange information or data, e.g., messages, via the inductive coupling of power driver 114 and power rectifier 124. For example, before PTx 110 begins transferring power to PRx 120, a power contract may be agreed upon and created between PRx 120 and PTx 110. For example, PRx 120 may send communication packets or other data to PTx 110 that indicate power transfer information such as, e.g., an amount of power to be transferred to PRx 120, commands to increase, decrease, or maintain a power level of AC power 130, commands to stop a power transfer, or other power transfer information. In addition, PTx can send data to the PRx to customize the power contract to its capabilities before beginning the power transfer. In another example, in response to PRx 120 being brought in proximity to PTx 110, e.g., close enough such that a transformer may be formed by coil TX and coil RX to facilitate power transfer, PRx 120 may be configured to initiate communication by sending a signal to PTx 110 that requests a power transfer. In such a case, PTx 110 may respond to the request by PRx 120 by establishing the power contract or beginning power transfer to PRx 120, e.g., if the power contract is already in place.

PTx 110 and PRx 120 may transmit and receive communication packets, data, or other information via the inductive coupling of coil TX and coil RX. As an example, communication packets sent from PTx 110 to PRx 120 may comprise frequency shift key (FSK) signals 134. FSK signals 134 are frequency modulated signals that represent digital data using variations in the frequency of a carrier wave. Communication packets sent from PRx 120 to PTx 110 may comprise amplitude shift key (ASK) signals 136. ASK signals 136 are amplitude modulated signals that represent digital data using variations in the amplitude of a carrier wave. While PTx 110 is described as sending FSK signals 134 and power receiver 120 is described as sending ASK signals 136, in other embodiments, PRx 120 may alternatively send FSK signals and PTx 110 may alternatively send ASK signals. Any other manner of transmitting communication packets, data, or other information between PTx 110 and PRx 120 may alternatively be used.

CPU and memory subsystem 122 of PRx 120 is configured to communicate with an application processor (AP) 128 of device 140. AP 128 may be considered the brain of device 140 and is configured to execute, manage, and control the various operations and functionality of device 140. As an example, AP 128 may comprise circuitry that integrates the hardware and software for performing multiple device functions into a single chip, e.g., such as those used in mobile devices like smart phones, tablets, etc. While mobile devices are referred to as an example, any other devices that are capable of receiving power wirelessly for charging or other purposes may also or alternatively be used.

AP 128 may comprise circuitry and software including one or more of a CPU, communication interfaces, camera processing, video interface, neural processing unit (NPU), digital signal processor (DSP), graphics processing unit (GPU), image signal processor (ISP), video processing, audio processing, security, user interface functions any other circuitry or software.

Some wireless power transfer standards establish that when power transfer terminates, PRx 120 will establish a clean system state and not maintain power transfer state information related to the charging session in memory subsystem 122B. Often, the clean system state may be established when power transfer has ended simply by memory subsystem 122B of PRx 120 becoming unpowered. For example, memory subsystem 122B may comprise volatile memory that does not store information when unpowered. In other cases, memory subsystem 122B may be cleansed at the termination of power transfer between PTx 110 and PRx 120.

In some cases, a short-term temporary power supply, such as a capacitor, may be utilized by PRx 120 to supply power to CPU and memory subsystem 122 for short duration memory retention needs such as, e.g., ping detection when PTx 110 is attempting to establish a power contract with PRx 120. However, such a power supply may not be sufficient to support the maintenance of power transfer state information by memory subsystem 122B during a temporary power transfer interruption.

In some scenarios, for example, power transfer may be suspended or interrupted, e.g., due to a thermal event, detection of a foreign object between PTx 110 and PRx 120 or for any other reason. In such a scenario, a loss of the power transfer state information stored in memory subsystem 122B may be detrimental to the charging process where, for example, such power transfer state information, and the power transfer contract itself, may need to be re-established once the event is resolved and charging continues.

As part of the power transfer process, PTx 110 and PRx 120 are configured to communicate information and data packets to each other about the power transfer process, e.g., using FSK and ASK or other communication mechanisms. As an example, PTx 110 and PRx 120 may initially communicate to form a power transfer contract and initiate power transfer, with PRx 120 entering a power transfer mode. When power transfer is complete, PTx 110 and PRx 120 may communicate regarding the completion of the power transfer and PRx 120 may transition to a power transfer off mode in which power transfer between PTx 110 and PRx 120 is terminated. In the power transfer off mode, memory subsystem 122B may no longer be powered and the power transfer state information may be lost or otherwise cleared. While power transfer mode and power transfer off mode are mentioned herein, other modes may also be available.

In some cases, power transfer may be temporarily suspended by PTx 110 or PRx 120, e.g., due to a thermal event, foreign object detection or for any other reason. In such a case, PTx 110 and PRx 120 may communicate or otherwise perform a handshake to have PRx 120 enter into a mode where power transfer is temporarily suspended, also referred to herein as cloak mode. However, when the power transfer is suspended, even temporarily, the power transfer state information maintained in memory subsystem 122B may be lost, e.g., due to memory subsystem 122B becoming unpowered as mentioned above. While one or more capacitors may be utilized to supply power to memory subsystem 122B to temporarily maintain data integrity, the use of capacitors may provide only a limited duration of power backup for memory subsystem 122B and may not be sufficient where the temporary suspension of power transfer requires a longer period of time.

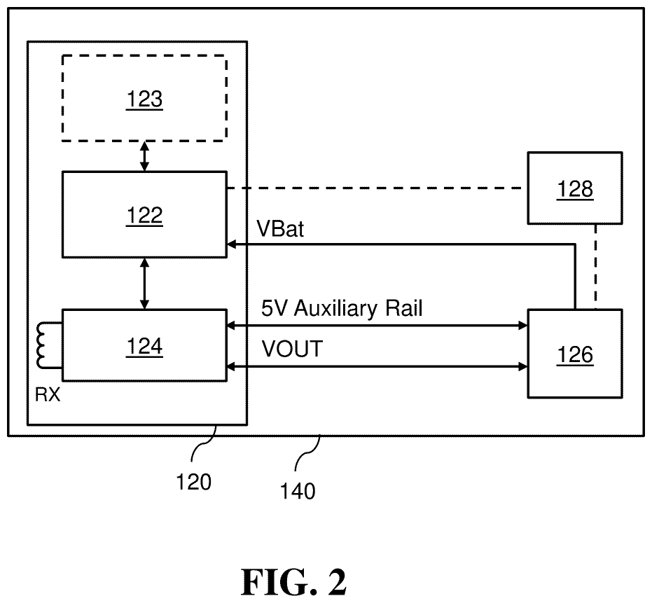

With reference to FIG. 2, in an embodiment, PRx 120 is configured to obtain power for maintaining the power transfer state information from device 140 during a temporary suspension of power transfer, e.g., from a load 126 of device 140 such as a battery. PRx 120 may be configured to obtain power from load 126 in a variety of manners according to various embodiments herein.

In an embodiment, for example, PRx 120 may communicate with AP 128 via data packets. AP 128 may receive data packets from PRx 120 which indicate to AP 128 that PRx 120 requires power from load 126. AP 128 may then cause load 126 to supply power to PRx 120.

In an embodiment, under a default configuration, power transfer can occur from PTx 110 to PRX 120 such that power rectifier 124 can receive power from PTx 110 and supply power to load 126 (e.g., to charge a battery in load 126) via the VOUT rail and supply power to various components and functions (e.g., integrated circuits (ICs), controllers, or to supply bias) of PRx 120. Also under the default configuration, when auxiliary power is active, power rectifier 124 can receive power from PTx 110 and supply power to load 126 via the VOUT rail and load 126 can supply power to various components and functions of PRx 120 via the 5V auxiliary rail. In some embodiments, boost or buck regulators may be utilized to generate VOUT, 5V auxiliary rail from load 126. In one embodiment, the power transfer from PTx 110 to PRx 120 can be suspended under cloak mode, thus power rectifier 124 may not receive power from PTx 110 and cannot supply power to load 126 or other components of PRx 120. When PRx 120 is under cloak mode, AP 128 may actuate a switch to allow load 126 to supply power (e.g., Vbat) to memory subsystem 122 of PRx 120 via a voltage regulator (e.g., buck or boost) and the 5V auxiliary rail. In another embodiment, AP 128 may actuate a switch to allow load 126 to directly supply power (e.g., Vbat) to memory subsystem 122 of PRx 120.

In another embodiment, device 140 may comprise a specialized VBat connection between load 126 and CPU and memory subsystem 122 which may receive a smaller voltage than the VOUT connecting load 126 to power rectifier 124. In some embodiments, boost or buck regulators may be utilized to generate VBat from load 126. VBat connects load 126 with CPU and memory subsystem 122 while bypassing power rectifier 124 and other circuitry of PRx 120 such that only those components needed for maintaining the power transfer state information are powered, thereby minimizing the system power draw when PRx 120 is in cloak mode or other modes for which power may need to be supplied to CPU and memory subsystem 122 from load 126. As mentioned above, in some embodiments, AP 128 may actuate a switch to provide power from load 126 to VBat.

In other embodiments, any other power connection may be utilized to supply power from load 126 to CPU and memory subsystem 122.

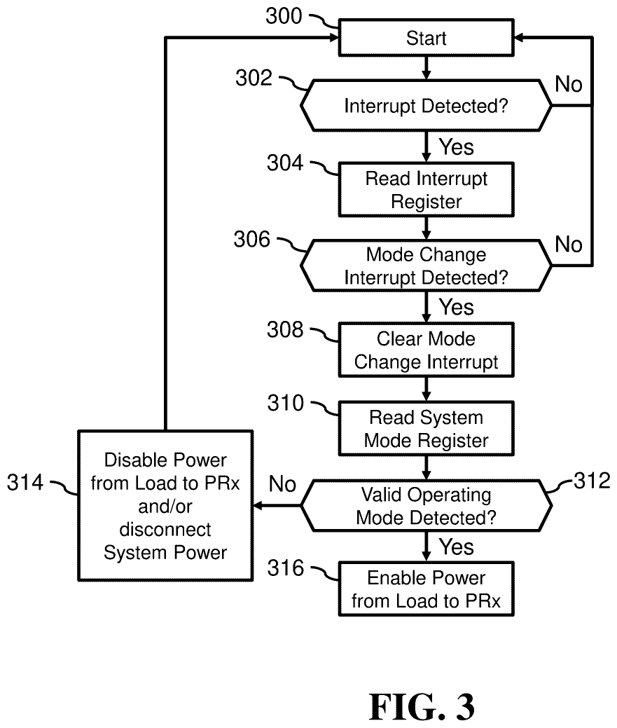

With reference to FIG. 3, in another embodiment, PRx 120 may also or alternatively trigger an interrupt for AP 128 to activate power supply from load 126 to the components of PRx 120. FIG. 3 illustrates an example process for activating power to PRx 120 when PRx 120 enters cloak mode and power transfer from PTx 110 to PRx 120 is temporarily suspended. The process of FIG. 3 comprises steps 300 through 316. At the start of the process of FIG. 3, PTx 110 and PRx 120 communicate regarding a temporary suspension of power transfer, e.g., by performing a cloak mode handshake or other communication, PRx 120 enters cloak mode, PRx 120 sets a PRx mode register to a value corresponding to cloak mode and PRx 120 issues a mode change interrupt to AP 128. In some embodiments, other values may be used as a proxy for the mode of PRx 120 such as, e.g., VRECT ON status, GPOD pin values or other outputs that correspond or may be utilized to infer the mode of PRx 120.

At step 300, the process starts.

At step 302, AP 128 determines whether an interrupt has been detected as part of its normal processing. If no interrupt has been detected, the process returns to step 300. If an interrupt has been detected, AP 128 proceeds to step 304.

At step 304, AP 128 reads the interrupt register.

At step 306, AP 128 determines whether the interrupt in the interrupt register corresponds to a mode change interrupt. If the interrupt does not correspond to a mode change interrupt, the process returns to step 300. If the interrupt corresponds to a mode change interrupt, the process proceeds to step 308.

At step 308, AP 128 clears the mode change interrupt.

At step 310, AP 128 reads the PRx mode register.

At step 312, AP 128 determines whether the value in the PRx mode register corresponds to cloak mode or another valid operating mode for which power needs to be supplied from load 126 to PRx 120. If the value does not correspond to cloak mode or another valid operating mode, power flow from load 126 to PRx 120 is disabled at step 314 and the process returns to step 300. In one or more embodiments, at step 314, AP 128 can also disconnect PRx controller 122a from system power of PRx 120. If the value corresponds to cloak mode or another valid operating mode, power flow from load 126 to PRx 120 is enabled at step 316, e.g., via the VOUT, 5V auxiliary rail, VBat or any other power connection.

While the above example process is described as having particular steps or steps in a particular order, in other embodiments only some of the steps may be performed or the steps may be performed in any other order.

In this manner, power to memory subsystem 122B of PRx 120 for maintaining power transfer state information is supplied from load 126 in the event of a temporary suspension of power transfer between PTx 110 and PRx 120 or for other valid operating modes for which power needs to be supplied from load 126 to PRx 120.

While the above process is described in relation to a detection of a value corresponding to cloak mode in the PRx mode register, other valid operating modes having other values may also cause power to be supplied to PRx 120 from load 126, such as, transceiver (TRx) mode, magnetic secure transmission (MST) mode, or other modes that use external power.

The process of FIG. 3 may also occur when PRx 120 exits cloak mode, e.g., returns to a power transfer mode, transitions to power transfer off mode or transitions to another mode for which the power transfer state information stored in memory subsystem 122B need not be maintained. For example, any time PRx 120 changes modes, an interrupt may be triggered for AP 128 causing the process of FIG. 3 to occur. In the case where the mode of PRx 120 is not cloak mode or another valid operating mode for which the power transfer state information need be maintained or other components of PRx 120 need power, power supply from load 126 to PRx 120 will be disabled at step 314. Another example of an invalid operating mode may be a mode change caused by controller 122A or AP 128 commanding an end to the power supply.

If the power supply output of PRx 120 to load 126 turns off without a mode change warning such as, e.g., an indication that PRx 120 has transitioned to cloak more or another valid operating mode via data packets or interrupts, AP 128 may use this lack of power supply as an indicator to disable any power supply to PRx 120 from load 126. For example, the power supply output from PRx 120 may turn off when device 140 is removed from proximity to PTx 110.

In another embodiment, PRx 120 does not request power from AP 128. As an example, PRx 120 may provide an indication to AP 128 that PRx 120 is connected to PTx 110 and initiating power transfer, e.g., via a message packet, interrupt, or another method of communication. Based on this indication, AP 128 may begin providing power to PRx 120 from load 126 without receiving a request from PRx 120 and regardless of whether PRx 120 is in cloak mode or another valid operating mode. In some cases, even where PTx 110 and PRx 120 are initiating power transfer operations.

While battery power consumption may be increased due to AP 128 providing power without a specific indication from PRx 120 that power supply from load 126 is needed, the speed at which AP 128 may initiate the power supply from load 126 to PRx 120 is increased as compared to the above processes where AP 128 awaits a communication or interrupt before providing power.

For example, in some cases, CPU and memory subsystem 122 of PRx 120 may need to receive power from load 126 within a predetermined amount of time after transitioning to cloak mode to ensure that the power transfer state information is maintained. If the amount of time that it takes to for AP 128 to receive a power request from PRx 120 as a data packet or based on an interrupt and then act on it to supply power from load 126 to PRx 120 is greater than the predetermined amount of time, data loss may occur. By having AP 128 begin supplying power to PRx 120 based on an indication that PRx 120 has initiated a connection with PTx 110, power supply to PRx 120 can be ensured for maintaining the power transfer state information. The power supply may then be disabled based on a predetermined criteria such as the initialization of a power transfer between PTx 110 and PRx 120 or for any other reason. In some embodiments, the power supply from load 126 to CPU and memory subsystem 122 of PRx 120 may be active even while power transfer between PTx 110 and PRx 120 is occurring to ensure that in the event of a temporary suspension of the power transfer, CPU and memory subsystem 122 of PRx 120 will remain powered with a transition of PRx 120 to a power transfer off mode or another mode being configured to trigger AP 128 to disable the supply of power.

In some embodiments, AP 128 may connect PRx to an optional auxiliary battery 123 (e.g., an external battery) having an ultra-low power draw that is not in use by AP 128 or device 140 and is configured for PRx to draw power from battery 123 when deemed necessary. For example, PRx 120 can use the battery 123 for low power, e.g., 100 microamps, applications such as memory retention. In this embodiment, AP 128 may not be involved in the supply of power from auxiliary battery 123 to PRx 120 during cloak mode or other valid operating modes. As an example, auxiliary battery 123 may support use in shipping mode where the power draw from auxiliary battery 123 is negligible. Controller 122A may be configured to monitor auxiliary battery 123 and deactivate power if a voltage output of auxiliary battery 123 drops below a predetermined threshold that indicates that the battery is running out of charge. Auxiliary battery 123 may be configured to recharge during normal power transfer between PTx 110 and PRx 120, e.g., by siphoning off a portion of the power being provided to load 126 until fully charged.

Controller 122A may be configured to detect or determine a timeout event that indicates that the temporary suspension of power transfer between PTx 110 and PRx 120, and PRx 120's status in cloak mode, lasts longer than a predetermined threshold amount of time and deactivate the power draw from auxiliary battery 123 or load 126 accordingly. In some embodiments, upon detection that cloak mode has lasted longer than the predetermined threshold amount of time, PRx 120 may transition to the power transfer off mode or another mode that does not need power supply from auxiliary battery 123 or load 126.

The amount of battery charge for auxiliary battery 123 may correspond to the timeout event where, for example, when controller 122A detects that the charge on auxiliary battery 123 is below the predetermined threshold, controller 122A may also determine that the timeout event has occurred and deactivate the power draw from auxiliary battery 123 and transition PRx 120 to another mode of operation, such as resetting PRx 120 to a default power on mode.

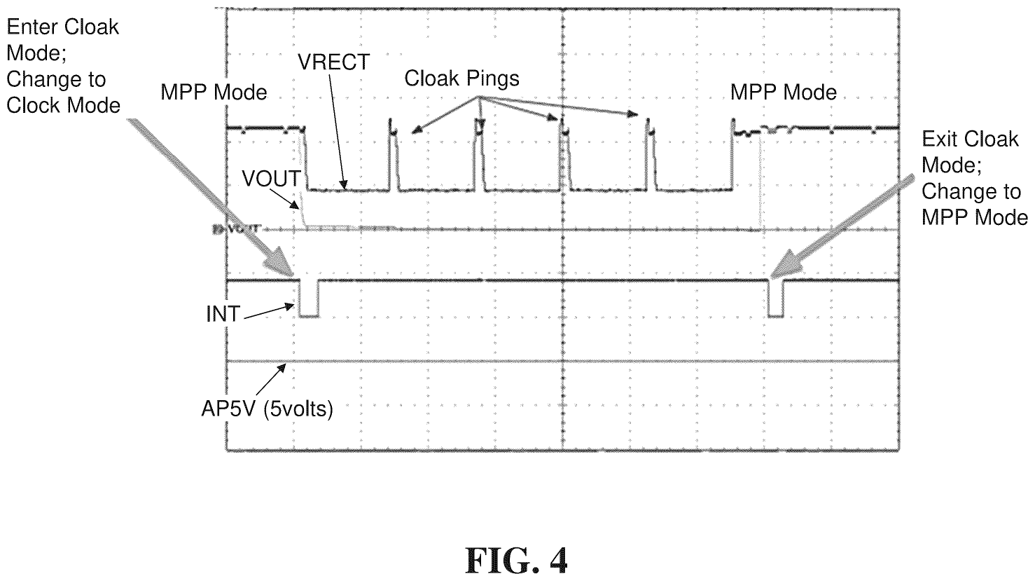

With reference to FIG. 4, an example signal diagram is shown that illustrates the transition of PRx 120 to and from cloak mode. In FIG. 4, four channels are presented, VRECT, VOUT, INT and AP5V. AP5V is set to 5V and PRx 120 initially starts up in MPP mode (power transfer mode). PRx 120 enters cloak mode, for example, by writing a value corresponding to cloak mode in the PRx mode register and triggering an interrupt on the INT channel. After some time, e.g., 2s, PRx 120 exits cloak mode by again writing a value corresponding to the exit from cloak mode to the PRx mode register and triggering another interrupt.

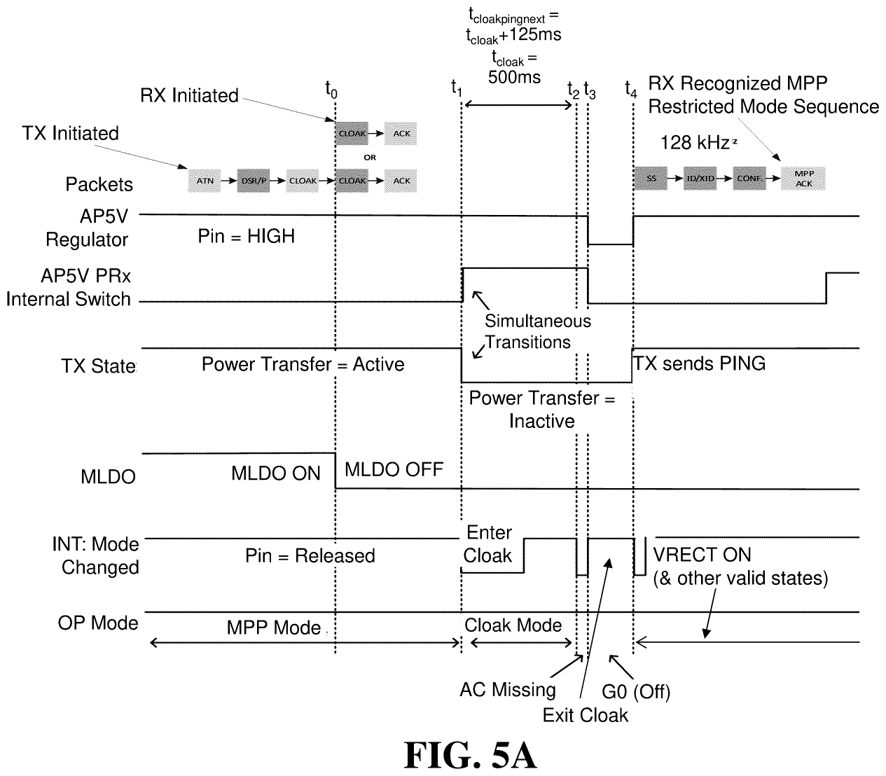

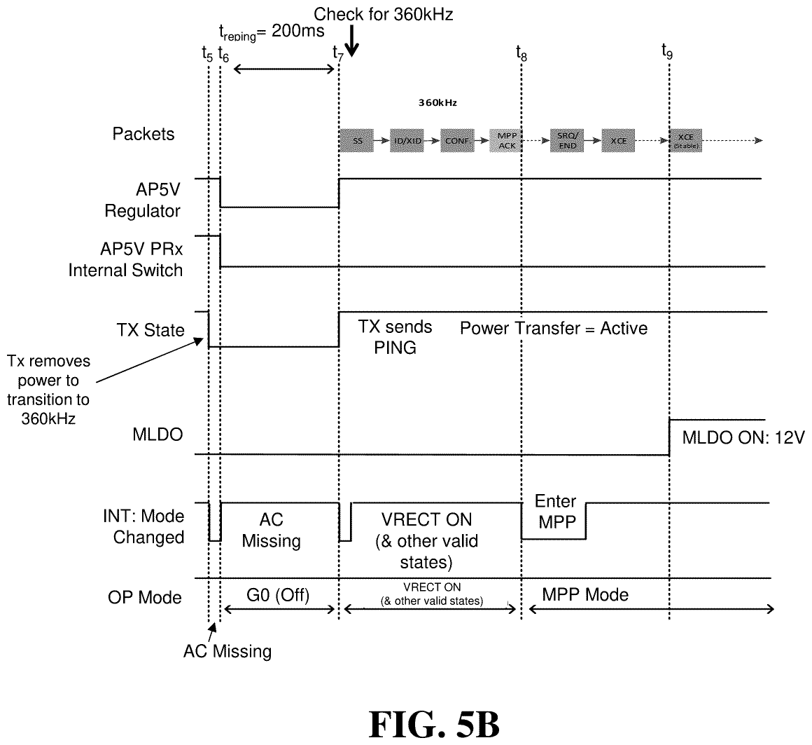

With reference to FIG. 5A add FIG. 5B, an example diagram showing state transitions, power application and removal is illustrated. PRx 120 is initially in the power transfer mode (MPP mode).

PTx 110 and PRx 120 perform a handshake process at time t₀ to establish a suspension of power transfer and transition of PRx 120 to cloak mode. The MLDO pin also transitions from ON to OFF.

At time t₁, PRx 120 transitions to cloak mode. The transition to cloak mode may be simultaneous with the deactivation of the power transfer between PTx 110 and PRx 120. The triggering of an interrupt by PRx 120 may also be simultaneous with the deactivation of the power transfer and transition of PRx 120 to cloak mode.

At time t₂, while in cloak mode, PRx 120 detects that the AC connection to PTx 110 is missing (e.g., expected PTx Cloak Ping did not occur) and PRx 120 exits cloak mode (e.g., PRx times out of cloak mode) to the power transfer off mode in a manner that indicates to AP 128 that a fault has occurred at time t₃. AP 128 also turns off the power supply from load 126 in response to the missing AC connection at time t₃. For example, AP 128 can disable the AP5V regulator or an external switch and PRx controller 122a can disable the AP5V Prx internal switch.

PTx 110 sends a ping at time t₄ to establish a new power contract and power transfer and performs a handshake with PRx 120. PRx 120 enters the VRECT ON mode. In some embodiments, AP 128 begins supplying power to PRx 120 based on PRx 120 establishing the power contract and initiating power transfer.

FIG. 5B continues the example shown in FIG. 5A. At time t₅, PTx 110 removes power to transition to 360 kHz which also causes PRx 120 to detect an AC missing event.

At time t6, AP 128 can remove power to PRx 120 by having the PRx controller 122a disable the AP5V PRx internal switch and having AP128 simultaneously shut down the AP5V regulator based on the AC missing event. PRx 120 also transitions to the power transfer off mode.

At time t₇, PTx 110 sends a ping to PRx 120 and activates power transfer. The AP5V regulator also becomes active and PRx 120 transitions to the VRECT ON mode. A handshake process for transferring power at 360 kHz is also performed between PTx 110 and PRx 120.

At time t₈, the handshake process is complete for transitioning PRx 120 from the VRECT ON mode to the power transfer mode (MPP mode).

At time t₉, the MLDO pin transitions from OFF to ON at 12V.

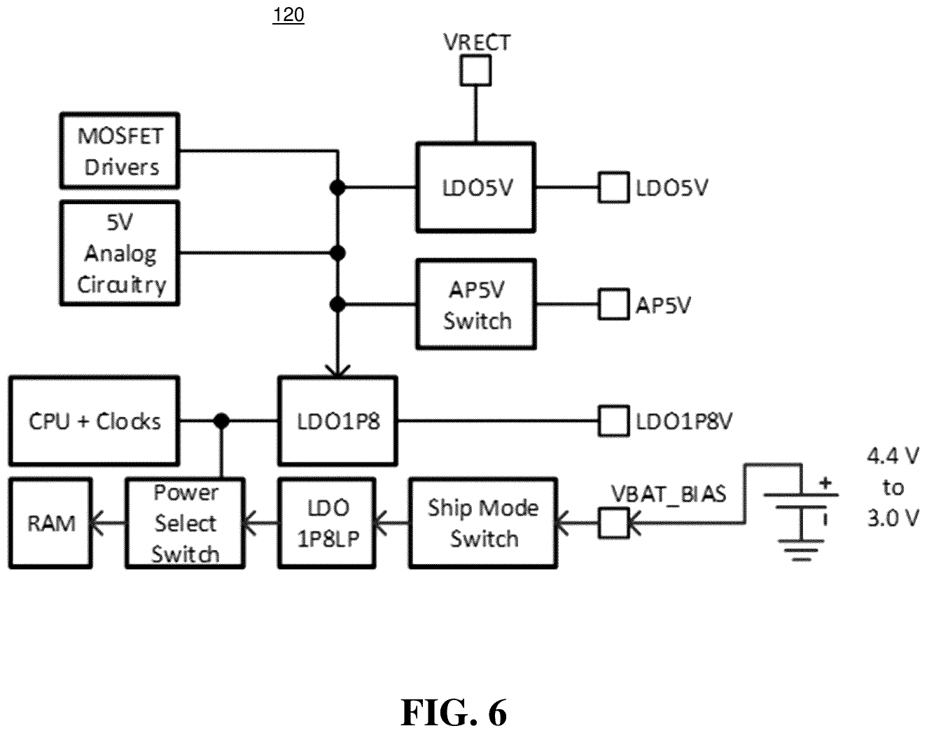

With reference to FIG. 6, a block diagram illustrating the different power supply input options for PRx 120 will be described. When in power transfer mode PRx 120 is receiving power via VRECT which supplies 5V power to the integrated circuit via an LDO5V. However, when PRx 120 enters cloak mode, VRECT is no longer powered. In this embodiment, PRx 120 is connected to load 126, e.g., a battery, via VBAT (VBAT_BIAS). As seen in FIG. 6, VBAT is controlled by a ship mode switch that may be utilized to set PRx 120 to ship mode. The ship mode switch comprises a switch that when activated may provide a true high impedance isolation between PRx 120 and the battery In some embodiments, an optional LDO may be utilized to down regulate the VBAT voltage. Could be the same or different than LDO1P8.

A power select switch may be used or power gating may be used to disable some, or all of the circuitry connected to the typical 1p8 LDO. Power supplied by VBAT may power the entire memory array or may alternatively power a minimum number of dedicated bits depending on the needs of PRx 120 when in the cloak mode. The supply may power the entire memory array or only a minimum number a dedicated bits as required by the cloaking function (PTx ID for example). For example, the memory element may be completely separate (with its own supply) from the main CPU+CLOCKs+RAM subsystems.

By removing the need for PRx 120 to receive power from PTx 110 to maintain power transfer state information during a temporary suspension of power transfer, the disclosed embodiments enhance the capabilities of PRx 120 and device 140 and limit the impact of temporary suspensions to the power transfer on the power transfer state of PRx 120 and the user of device 140.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The disclosed embodiments of the present invention have been presented for purposes of illustration and description but are not intended to be exhaustive or limited to the invention in the forms disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. An apparatus comprising:
a battery; and
a wireless power receiver, the wireless power receiver comprising a controller and a memory subsystem, the controller being configured to:
perform a handshake with a wireless power transmitter, the handshake corresponding to a temporary suspension of a power transfer between the wireless power transmitter and the wireless power receiver;
transition the wireless power receiver from a power transfer mode, in which power is transferred wirelessly from the wireless transmitter to the wireless receiver, to a cloak mode, in which the power transfer is suspended, based on the handshake; and
obtain a supply of power from the battery based on the transition to the cloak mode, the power being configured for use by the controller to maintain power transfer state information about the temporary suspension of a power transfer in the memory subsystem.

2. The apparatus of claim 1, wherein:
the apparatus comprises an application processor that is configured to control power flow from the battery; and
obtaining the supply of power from the battery comprises the application processor causing the power to be provided from the battery to the controller.

3. The apparatus of claim 2, wherein the controller is configured to request that the application processor provide power from the battery to the controller by submitting a data packet comprising a request for power to the application processor.

4. The apparatus of claim 2, wherein the controller is configured to request that the application processor provide power from the battery to the controller by setting a register to a value corresponding to one of the cloak mode and an invalid mode, and triggering an interrupt to the application processor that corresponds to the register, the application processor being configured to read the register and provide the power from the battery to the controller based on the value of the register.

5. The apparatus of claim 2, wherein the application processor is configured to cause the battery to supply power to the controller based on an initial handshake between the power transmitter and the power receiver, the initial handshake establishing a power contract between the power transmitter and the power receiver and initiating power transfer.

6. The apparatus of claim 2, wherein the application processor is configured to terminate the supply of power by based on a change in a mode of the power receiver that corresponds to an invalid mode, wherein termination of the supply of power comprises disconnecting the controller from system power of the power receiver.

7. The apparatus of claim 6, wherein the controller is configured to determine that a predetermined amount of time since entering cloak mode has elapsed and to cause the application processor to terminate the supply of power based on the determination that the predetermined amount of time has elapsed.

8. The apparatus of claim 1, wherein the controller is configured to:
determine that a voltage output of the battery has dropped below a predetermined threshold value; and
terminate the supply of power from the battery based on the determination that the voltage output of the battery has dropped below the predetermined threshold value.

9. The apparatus of claim 8, wherein the battery is an auxiliary battery specific to the power receiver, the apparatus further comprising a primary battery, the power receiver being configured to charge the primary battery when in the power transfer mode.

10. An apparatus comprising an application processor and a battery, the application processor being configured to:
receive an indication of a change in state of a wireless power receiver;
determine that the change in state corresponds to a temporary suspension of a power transfer; and
cause power to be supplied to the wireless power receiver from the battery based on the determined change in state.

11. The apparatus of claim 10, wherein the application processor is configured to determine that the change in state corresponds to the wireless power receiver transitioning to a cloak mode.

12. The apparatus of claim 10, wherein the indication comprises a data packet received from the wireless power receiver.

13. The apparatus of claim 10, wherein the indication comprises an interrupt triggered by the wireless power receiver.

14. The apparatus of claim 13, wherein the application processor is configured to:
read a register corresponding to the interrupt; and
determine that the register corresponding to the interrupt contains a value corresponding to a wireless power receiver mode register.

15. The apparatus of claim 14, wherein the application processor is configured to:
read the wireless power receiver mode register to determine a mode of the wireless power receiver;
determine that the mode is a cloak mode; and
cause the power to be supplied to the wireless power receiver from the battery based on the determination that the mode is a cloak mode.

16. The apparatus of claim 15, wherein the application processor is configured to:
read the wireless power receiver mode register to determine the mode of the wireless power receiver based on a receipt of a second interrupt;
determine that the mode is another mode that is invalid for receiving power from the battery; and
deactivate the power being supplied to the wireless power receiver from the battery based on the determination that the mode is invalid for receiving power from the battery.

17. The apparatus of claim 15, wherein the application processor is configured to:
determine that a predetermined amount of time since entering cloak mode has elapsed; and
terminate the power being supplied based on the determination that the predetermined amount of time has elapsed.

18. An apparatus comprising a wireless power receiver, the wireless power receiver being configured to:
establish a power transfer contract with a wireless power transmitter;
provide an indication to an application processor of the apparatus that corresponds to the establishment of the power transfer contract, the application processor being configured to receive the indication that the wireless power receiver has established a power transfer contract with the wireless power transmitter and cause power to be supplied to the wireless power receiver from a battery based on the receipt of the indication;
provide the power received from the battery to a memory subsystem of the wireless power receiver, the memory subsystem being configured to maintain power transfer state information corresponding to the power transfer contract; and
execute a wireless power transfer between the wireless power transmitter and the wireless power receiver based on the power transfer contract and provide the transferred power to the battery.

19. The apparatus of claim 18, wherein the wireless power receiver is configured to both supply power to the battery from the wireless power transfer and receive power from the battery for the memory subsystem.

20. The apparatus of claim 18, wherein the wireless power receiver is configured to disable the power being received from the battery based on the execution of the wireless power transfer between the wireless power transmitter and the wireless power receiver.
